(19) United States
(12) Patent Application Publication
(10) Pub. No.: US 2009/0052481 A1
(43) Pub. Date: Feb. 26, 2009

(54) Laser light source device and image generating device using same

(75) Inventors: Kaoru Kimura, Tokyo (JP); Michio Oka, Tokyo (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: Sony Corporation

(21) Appl. No.: 12/228,967

(22) Filed: Aug. 18, 2008

(30) Foreign Application Priority Data
Aug. 23, 2007 (JP) P2007-217503

(51) Int. Cl. H01S 3/10; H01S 3/081

(52) U.S. Cl. 372/26; 372/93

(57) ABSTRACT

Disclosed herein is a laser light source device including a pumping light source; a pair of resonator mirrors; a laser medium and a wavelength converting element within a resonator formed by the resonator mirrors; the laser medium being pumped by light in a transverse multi-mode pattern, the wavelength converting element being irradiated with a linear fundamental wave obtained by oscillation of the laser medium, and a linear converted wave being output; a reflecting part for folding back a resonant light path, the reflecting part being disposed on the light path between the laser medium and the wavelength converting element; an end surface of one of the laser medium and the wavelength converting element being formed as an inclined surface at other than a Brewster angle; and a polarizing film disposed on the inclined surface.

### CROSS REFERENCES TO RELATED APPLICATIONS

The present invention contains subject matter related to Japanese Patent Application JP 2007-217503 filed in the Japan Patent Office on Aug. 23, 2007, the entire contents of which being incorporated herein by reference.

### BACKGROUND OF THE INVENTION

1. Field of the Invention

The present invention relates to a laser light source device that outputs linear converted light in a one-dimensional transverse multi-mode or the like as a result of internal resonator type wavelength conversion, and an image generating device using the same.

2. Description of the Related Art

In various optical devices using a laser light source, such as projectors, laser printers, process devices and the like, a laser light source device that has a small size, consumes low power, and provides stable output is desired. In particular, in a laser light source device that has a resonator structure using a wavelength converting element such as a nonlinear optical crystal or the like and which also has a function of converting a fundamental wave into a converted wave such as a harmonic or the like, a constitution has been proposed in which a folding-back mirror is provided at a midpoint in a resonator in order to achieve miniaturization while securing a predetermined resonator length.

In addition, to obtain high conversion efficiency by reducing mode diameter in the wavelength converting element and increasing the power density of the fundamental wave at this time, a constitution provided with a folding-back mirror having an effective curvature has been proposed.

When a solid-state laser using a semiconductor laser as a pumping light source is used in such a laser light source device, outputting a linear (for example elliptic) converted wave, in particular, using pumping light in the one-dimensional transverse multi-mode by an array laser or the like has been proposed to remedy illumination variations caused by interference (see Japanese Patent Laid-Open No. 2006-66818 (hereinafter referred to as Patent Document 1), for example).

When light in such a transverse multi-mode is used in an image generating device, for example, image quality can be improved because a light modulating device can be illuminated relatively uniformly, speckle noise can be reduced because of the transverse multi-mode, and a highly efficient laser light source device is expected to be obtained without complicating device configuration.

In addition, various devices have been made to avoid parasitic oscillation of a fundamental wave due to polarized light other than desired polarized light and variations in output of a converted wave due to the parasitic oscillation in a laser light source device that has a resonator structure using a wavelength converting element such as a nonlinear optical crystal or the like as described above. Methods of adding a part are generally adopted, including for example a method of inserting a polarizer in a resonator and a method of disposing a glass plate or the like at a Brewster angle with respect to an optical axis and thus inserting the glass plate or the like in a resonant light path.

However, when an efficient second harmonic generation is to be obtained using wavelength conversion within a resonator as in the above-mentioned Patent Document 1, light is focused onto a wavelength converting element using a concave mirror, and therefore a resonant light path is folded. Thus, a harmonic is generated at an awkward angle with respect to a pumping direction in an end pump system, for example. At this time, when working is provided so as to have a Brewster angle at an end surface of a laser medium, the angle of generation of the harmonic with respect to the pumping direction is changed (see Japanese Patent Laid-Open No. Hei 05-267756 (hereinafter referred to as Patent Document 2), for example).

### SUMMARY OF THE INVENTION

However, the following problems arise when working is provided so as to have a Brewster angle at an end surface of a crystal as in a method disclosed in the above Patent Document 2. The Brewster angle is uniquely determined by the refractive index of a laser medium and a material for the wavelength converting element. Hence, when an end surface of a laser medium or the like is worked at a Brewster angle and light is made to enter and be emitted from the laser medium, depending on the angle, a converted wave such as a harmonic or the like may be generated in an awkward angle with respect to the pumping direction.

In order to avoid emission in an inconvenient direction, it suffices to use a separate Brewster plate or the like. In this case, however, an increase in the number of parts is inevitable. Further, even in this case, when a resonant light path is folded by using a concave mirror, the pumping direction and the direction of the harmonic may not be made parallel to each other because of a finite effective diameter of an optical system. Therefore device configuration becomes complex.

As described above, the direction of emission of the converted wave is uniquely determined by the Brewster angle of the material. When an emission light path is set in a direction different from the above direction, the following problems arise. For example, there is a case of forming a constitution in which the converted wave is emitted in a direction parallel to the pumping direction of pumping light to simplify optical adjustment work. In order to form such a constitution while working is performed so as to have a Brewster angle at an end surface of the crystal, an extra member for bending a light path such as a folding-back mirror or the like is necessary, thus inviting an increase in the number of parts. An increase in the number of parts correspondingly complicates optical adjustment work, and affects optical characteristics, cost, and the like.

In particular, when a linear beam is folded back by a concave mirror in particular, the occurrence of aberration becomes a problem. A small folding-back angle is therefore desirable. In addition, depending on the size of a beam, there arises a need to increase the effective diameter of the folding-back mirror, which is disadvantageous for miniaturization.

In view of the above problems, it is desirable to suppress parasitic oscillation of a fundamental wave due to polarized light other than desired polarized light and variations in output of a converted wave due to the parasitic oscillation in outputting the linear converted wave as described above, reduce an increase in the number of parts of a device, simplify the layout of a resonator, and simplify device configuration.

A laser light source device according to an embodiment of the present invention includes a pumping light source and a pair of resonator mirrors; and a laser medium and a wavelength converting element within a resonator formed by the resonator mirrors. Then, the laser medium is pumped by light in a transverse multi-mode pattern, the wavelength converting element is irradiated with a linear fundamental wave obtained by oscillation of the laser medium, and a linear converted wave is output. A reflecting part for folding back a resonant light path is disposed on the light path between the laser medium and the wavelength converting element. An end surface of one of the laser medium and the wavelength converting element is formed as an inclined surface at other than a Brewster angle. A polarizing film is disposed on the inclined surface.

Further, an image generating device according to an embodiment of the present invention includes a laser light source device of the above-described present invention configuration; a light modulating unit for modulating light emitted from the laser light source device so as to correspond to information; and a projection optical unit. That is, the laser light source device includes a pumping light source and a pair of resonator mirrors, and a laser medium and a wavelength converting element within a resonator formed by the resonator mirrors. Then, the laser medium is pumped by light in a transverse multi-mode pattern, the wavelength converting element is irradiated with a linear fundamental wave obtained by oscillation of the laser medium, and a linear converted wave is output. A reflecting part for folding back a resonant light path is disposed on the light path between the laser medium and the wavelength converting element. A polarizing film is disposed on an end surface of the laser medium.

As described above, in the laser light source device according to the foregoing embodiment of the present invention and the image generating device using the same, in outputting a converted wave in the transverse multi-mode pattern, a reflecting part for folding back a resonant light path is disposed on the light path between the laser medium and the wavelength converting element, and a polarizing film is disposed on an end surface of one of the laser medium and the wavelength converting element.

Because the reflecting part for folding back the resonant light path is disposed on the light path, the embodiment of the present invention can provide a smaller laser light source device. Then, in particular, by providing the polarizing film on an end surface of one of the laser medium and the wavelength converting element, it is possible to sufficiently suppress parasitic oscillation of the fundamental wave due to polarized light other than desired polarized light and suppress variations in output of the converted wave due to the parasitic oscillation without using another optical element for polarization of light such as a Brewster plate or the like. In addition, the layout of the direction of emission of the converted wave or the like can be selected freely with respect to a pumping direction, the exhaust heat surface of the pumping light source, and the like. It is thus possible to surely suppress the above-described parasitic oscillation without complicating the layout of the resonator within the laser light source device.

Further, in the laser light source device according to the foregoing embodiment of the present invention, an end surface of one of the laser medium and the wavelength converting element is formed as an inclined surface at other than a Brewster angle, and a polarizing film is provided to the inclined surface, thereby light emitted from the inclined surface of one of the laser medium and the wavelength converting element can be propagated at a desired angle. It is thus possible to reduce limitations to the arrangement of the reflecting part for folding back the resonant light path and configuration including effective diameter and the like, and to freely select a layout, as it were.

According to the laser light source device and the image generating device according to the foregoing embodiments of the present invention, it is possible to suppress parasitic oscillation of a fundamental wave due to polarized light other than desired polarized light and variations in output of a converted wave due to the parasitic oscillation in outputting the linear converted wave, reduce an increase in the number of parts of the devices, simplify the layout of the resonator, and simplify device configuration.

### BRIEF DESCRIPTION OF THE DRAWINGS

FIG. 1 is a schematic diagram of configuration of a laser light source device according to an embodiment of the present invention;

FIG. 2 is a schematic diagram of configuration of a laser light source device according to an embodiment of the present invention;

FIGS. 3A and 3B are a schematic plan configuration view and a schematic side configuration view of a laser light source device according to an embodiment of the present invention;

FIG. 4 is a diagram of assistance in explaining an angle of disposition of a laser light source device according to a comparative example;

FIG. 5 is a diagram of assistance in explaining an angle of disposition of a laser light source device according to an embodiment of the present invention; and

FIG. 6 is a schematic diagram of a configuration of an image generating device according to an embodiment of the present invention.

### DETAILED DESCRIPTION OF THE PREFERRED EMBODIMENT

An example of the best mode for carrying out the present invention will hereinafter be described. However, the embodiment of the present invention is not limited to the example below.

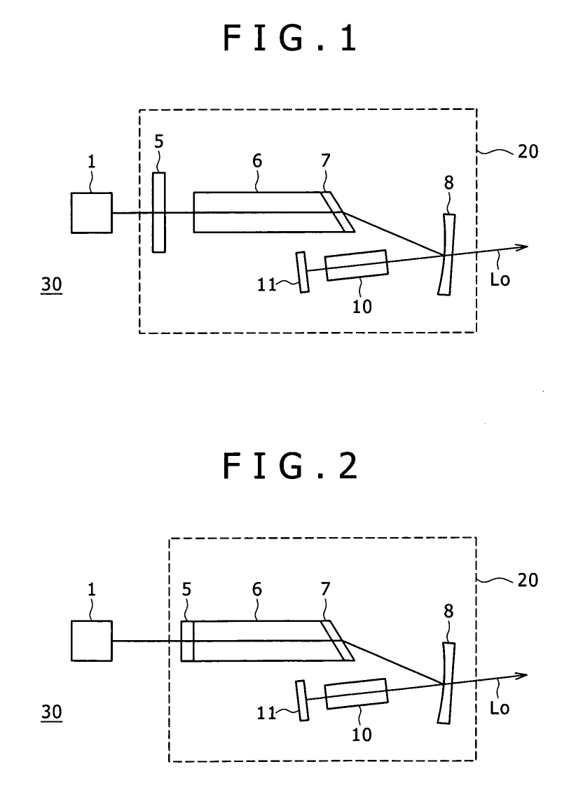

FIG. 1 and FIG. 2 are schematic diagrams of configuration of respective examples of a laser light source device according to an embodiment of the present invention. The laser light source device 30 shown in FIG. 1 has a pumping light source 1 and a pair of resonator mirrors 5 and 11. The laser light source device 30 also has a laser medium 6 and a wavelength converting element 10 within a resonator 20 (indicated by a broken line) formed by the resonator mirrors 5 and 11. The laser medium 6 is pumped by light in a transverse multi-mode pattern which light is emitted from the pumping light source 1 of a semiconductor laser array or the like. The wavelength converting element 10 is irradiated with a linear fundamental wave obtained by the oscillation of the laser medium 6, and then outputs a linear converted wave Lo. A reflecting part 8 for folding back a resonant light path is provided on the light path between the laser medium 6 and the wavelength converting element 10. An end surface of the laser medium 6 or the wavelength converting element 10, or an end surface of the laser medium 6 on the reflecting part 8 side in the example shown in FIG. 1, is an inclined surface at an angle of inclination other than a Brewster angle. A polarizing film 7 is provided on the inclined surface.

In the example shown in FIG. 2, which has a similar configuration to that of the example of FIG. 1, a resonator mirror 5 is formed as a high reflectance film having a high reflectance for a fundamental wave oscillating in a laser medium 6 on an end surface of the laser medium 6 on the side of a pumping light source 1. In FIG. 2, parts corresponding to those of FIG. 1 are identified by the same reference numerals, and repeated description thereof will be omitted. By thus forming the resonator mirror as a film, it is possible to reduce the number of parts and simplify optical adjustment.

The inclined surface provided to the laser medium 6 in the examples shown in FIG. 1 and FIG. 2 is formed as a surface at an angle of inclination other than the Brewster angle for the entrance and emission of the fundamental wave oscillating within the laser medium 6 due to pumping light emitted from the pumping light source 1.

Thus, at least one side end surface of the entrance and emission surfaces of the laser medium and the wavelength converting element is worked so as to be an inclined surface for the entrance and emission of the fundamental wave. Further, the polarizing film is provided which combines different functions, as it were, by being provided with a reflection preventing function for desired polarized light and being provided with a function of lower transmittance for other than the desired polarized light as compared with that of the reflection preventing function. Parasitic oscillation due to polarized light other than the desired polarized light can thereby be suppressed sufficiently. Further, the optical path of light emitted from the inclined surface can be selected freely, and in constructing a device, a layout of the direction of emission of the converted wave and the like with respect to a pumping direction, the exhaust heat surface of the pumping light source, and the like can be selected freely. Thus, a layout of a resonator within the laser light source device can be selected freely without being complicated, and the above-described parasitic oscillation can be surely suppressed.

In a wavelength converting element formed by an ordinary nonlinear optical crystal or the like, the polarized light of the fundamental wave that can be subjected to wavelength conversion efficiently is determined, so that even when other polarized light is made incident, wavelength conversion is not performed, or conversion efficiency is low as compared with the desired polarized light. Thus, there is an existing problem in that parasitic oscillation of the fundamental wave due to the polarized light other than the desired polarized light leads directly to variations in output of the converted wave. The variations in output of the converted wave are caused by polarized light variations, and are thus far greater than variations in output of the fundamental wave due to the parasitic oscillation itself. On the other hand, according to the embodiment of the present invention, polarized light is aligned merely by providing the polarizing film 7. Thus, in addition to effects described above, the embodiment of the present invention also provides an effect of being able to provide a stable laser device with little output variation without increasing the number of parts and without complicating a layout.

It suffices for the polarizing film provided to the laser medium 6 or the wavelength converting element 10 in the laser light source device according to the embodiment of the present invention to satisfy the following transmission condition. That is, the polarizing film 7 is formed so as to have higher transmittance (for example a transmittance of 99.8%) for the polarized light of the fundamental wave in a direction in a plane of incidence at the inclined surface of the laser medium 6 or the wavelength converting element 10 and have lower transmittance (for example a transmittance of 98%) for the polarized light of the fundamental wave in a direction perpendicular to the plane of incidence.

Incidentally, in order for a polarized light selecting effect to manifest within the resonator, it suffices to have a difference in transmittance between the desired polarized light and the polarized light desired not to cause parasitic oscillation, and the transmittance for the polarized light whose parasitic oscillation is desired to be avoided does not necessarily need to be zero. This is because polarized light oscillates whose loss in one round due to transmittance (reflectance) for the fundamental wave within the resonator is merely slightly lower.

Even with a Brewster surface for the same purpose of suppressing parasitic oscillation, transmittance for S-polarized light whose parasitic oscillation is desired to be avoided is 29% at a wavelength of 1064 nm in a case of Nd:YAG (a refractive index of 1.82). In the embodiment of the present invention, because the inclined surface is provided with the polarizing film without being formed as a Brewster surface, the transmittance does not need to be set so low.

In the embodiment of the present invention, the polarizing film is provided to the inclined surface other than the Brewster surface to make a difference in transmittance for polarized light as described above, so that polarized light for which transmittance is high is made to oscillate and the fundamental wave has polarized light in the plane of incidence. That is, it is possible to reduce a transmission loss of polarized light in a resonant light path and suppress parasitic oscillation due to polarized light perpendicular to the resonant light path.

When the above-described difference in transmittance is about 0.5 percentage points or more, parasitic oscillation due to undesired polarized light can be suppressed, though depending on the materials of the laser medium and the wavelength converting element, the configuration of the laser resonator, and the level of the parasitic oscillation desired to be suppressed. A difference of less than 0.5 percentage points is not practical because there is a strong possibility that a difference of less than 0.5 percentage points is about a measurement error or a variation in characteristic of fabricated film. It is experimentally confirmed that a more desirable difference of 1.5 percentage points or more can sufficiently suppress parasitic oscillation.

To further increase the transmittance difference limits materials, the number of layers and the like of multilayer film forming the polarizing film, and affects cost. In addition, even when consideration is given to variations in film characteristic between lots in manufacturing, variations in effective refractive index with respect to a used orientation of a substrate crystal due to an axis shift in a case of using a birefringent crystal, variations in angle of the inclined surface, or the like, a transmittance difference of five percentage points can sufficiently suppress parasitic oscillation. Thus, it can be said that the transmittance difference of five percentage points or less is sufficient.

Moreover, unlike the Brewster angle, the angle range of the inclined surface for which the polarizing film having such functions can be designed is not uniquely determined by the refractive index of the material. The angle of the inclined surface can be selected relatively freely by properly designing a constitution including materials, the number of layers and the like of the polarizing film. Hence, the angle of inclination can be selected in consideration of miniaturization and ease of production of the laser light source device. For example, in a so-called end pump system in which the pumping light source is disposed in the rear of the laser medium, the pumping direction and the direction of emission of the converted wave such as a harmonic can be made substantially parallel to each other.

Incidentally, by forming this polarizing film such that the polarizing film has a sufficiently high transmittance for a direction of polarized light of the linear converted wave generated in the wavelength converting element, it is possible to provide the polarizing film on the end surface of the wavelength converting element as the inclined surface, and thus suppress parasitic oscillation of undesired polarized light of the fundamental wave and reduce a transmission loss of the converted wave.

In both cases of the embodiments of FIG. 1 and FIG. 2 described above, a parallel light source of semiconductor lasers, or a so-called laser array, can be used as the pumping light source 1. However, the pumping light source 1 is not limited to a laser array. In addition, while FIG. 1 and FIG. 2 illustrate an example of an end pump system, it is needless to say that the embodiment of the present invention can be applied to a side pump system in which the pumping light source 1 is disposed on a side of the laser medium 6. Further, various optical elements not shown in the above-described examples can be added. For example, a microlens may be used in both of a vertical direction and a horizontal direction between the pumping light source 1 and the pulse generating circuit 5 to convert the pumping light into a collimated beam, and a lens having a condensing function for condensing the collimated beam on the laser medium 6 may be further disposed. Needless to say, it is desirable to perform appropriate shaping of the beam of the pumping light according to a use and then apply the beam.

It is desirable to use a birefringent material as the laser medium used in the laser light source device according to the embodiment of the present invention. Usable as the birefringent material is for example one of YVO₄, GdVO₄, YLF, LISAF (LiSrAlF₆), LICAF (LiCaAlF₆), KGW (KGd(WO₄)₂), KYW (KY(WO₄)₂), and Ti³⁺:Al₂O₃ or materials formed by doping these materials with various ions (Nd, Yb, Ce, Na, Cr, Er, Ho, and Tm). Of these materials, YVO₄ has a particularly large birefringence.

The birefringent material thus used as the laser medium has an advantage of making it easy to surely set the transmittance difference of the polarizing film 7. Specifically, in the case of the birefringent crystal, as compared with an isotropic crystal, the number of films of the polarizing film can be generally reduced for a same angle of incidence. It is thus easy to design a larger transmittance difference. Hence, the birefringent material used as the laser medium has advantages in that a large characteristic difference can be provided for the polarizing plane and parasitic oscillation due to polarized light other than desired polarized light can be suppressed more surely. Alternatively, while an increase in scattering and absorption and a decrease in laser resistance generally occur with an increase in the number of films, a transmittance difference can be secured even when the number of films of the polarizing film is reduced. There is thus an advantage of being able to surely suppress parasitic oscillation due to polarized light other than desired polarized light while avoiding these undesirable effects. Alternatively, a transmittance difference can be provided even when the angle of inclination of the birefringent crystal to which the polarizing film is attached is decreased. There is thus an advantage of being able to surely suppress parasitic oscillation due to polarized light other than desired polarized light while selecting a resonator layout more freely.

Further, in addition to the above-described birefringent materials, for example solid-state laser materials to which a rare earth element is added, such as Nd:YAG obtained by doping yttrium aluminum garnet (Y₃Al₅Ol₂) with Nd ions, Yb:YAG and the like, can be selected as the laser medium according to a use. YAG or the like has another oscillation line in the vicinity of a used waveform. In this case, depending on the allowable wavelength range of the wavelength converting element and laser configuration, in particular, it is desirable that a wavelength selecting element for suppressing parasitic oscillation wavelength be further disposed within the resonator. For example, a birefringent filter formed by a rock crystal, can be used as the wavelength selecting element.

In addition, when for example YVO₄ having an anisotropic absorption characteristic and an anisotropic oscillation characteristic is used, it is desirable to make the direction of polarized light of the pumping light source, that is, the direction of polarized light to be absorbed by YVO₄ coincide with the direction of polarized light in YVO₄ to be oscillated. When the pumping light source is a semiconductor laser, depending on the oscillating polarized light of the pumping light source, it is desirable to set the pumping light to a necessary direction of polarization by for example rotating the direction of polarization by substantially 90 degrees using a half-wave plate (not shown) or the like before the pumping light enters the resonator.

A nonlinear optical crystal or a nonlinear optical element can be used as the wavelength converting element in the laser light source device according to the embodiment of the present invention. The wavelength converting element is for example used for wavelength conversion such as SHG (Second Harmonic Generation), THG (Third Harmonic Generation), or the like, or used for sum frequency generation, optical parametric oscillation or the like. Materials to be used include KTiOPO₄(KTP), β-BaB₂O₄ (BBO), LiB₃O₅ (LBO), LiTaO₃, LiNbO₃, congruent (uniform melt) compositions thereof, stoichiometric compositions thereof, and materials to which additives such as Mg, Zn and the like are added.

For example, crystalline materials can be used such as C—LiNbO₃, C—LiTaO₃, S—LiNbO₃, S—LiTaO₃, MgO:C—LiNbO₃, MgO:C—LiTaO₃, ZnO:C—LiNbO₃, ZnO:C—LiTaO₃, MgO:S—LiNbO₃, MgO:S—LiTaO₃, ZnO:S—LiNbO₃, ZnO:S—LiTaO₃, and the like.

In addition, crystalline elements obtained by subjecting these materials to a periodical polarization inversion process can be recited, such as PP—C—LiNbO₃, PP—C—LiTaO₃, PP—S—LiNbO₃, PP—S—LiTaO₃ (PPSLT), PP—MgO:C—LiNbO₃, PP—MgO:C—LiTaO₃, PP—ZnO:C—LiNbO₃, PP—ZnO:C—LiTaO₃, PP—MgO:S—LiNbO₃, PP—MgO:S—LiTaO₃, PP—ZnO:S—LiNbO₃, PP—ZnO:S—LiTaO₃, PP—KTiOPO₄, and the like.

Incidentally, “C” refers to “congruent (uniform melt) composition”, and “S” refers to “stoichiometric composition”. In addition, “PP” refers to “periodical poling (periodical polarization inversion)”. A nonlinear optical element having a periodical polarization inversion structure is obtained by performing periodical polarization control on a nonlinear optical crystal by voltage application or the like. These materials are worked at an appropriate angle satisfying a phase matching condition according to a used wavelength, or an appropriate periodical polarization inversion structure is created, thereby satisfying a (pseudo) phase matching condition.

The size of the wavelength converting element is desirably larger by an appropriate amount than the linear beam size of the fundamental wave and the converted wave within the resonator.

Incidentally, the direction of polarization of the fundamental wave entering the wavelength converting element is made to coincide with an appropriate direction of the wavelength converting element according to a phase matching condition. For example, in the case of PPSLT, when a fundamental wave having a direction of polarization in a z-direction (a direction perpendicular to a wafer surface) of the crystal is made incident, a harmonic in the same direction of polarization can be generated efficiently. In this case, it is appropriate to perform periodical polarization inversion so as to propagate in a direction in the wafer surface with a c-axis as the direction of a normal. However, because the thickness of a wafer is generally about 1 mm or less, when light in a transverse multi-mode is handled as in the embodiment of the present invention, the longitudinal direction of the beam is desirably the direction in the wafer surface. Hence, the directions of polarization of the fundamental wave and the converted wave in this case are both a direction substantially perpendicular to the longitudinal direction.

On the other hand, a wavelength converting element for which periodical polarization inversion is not used, such as LBO or the like, can have a somewhat large element size about a few mm square. It is therefore possible to make the direction of polarization parallel with the longitudinal direction of the beam or make the direction of polarization perpendicular to the longitudinal direction of the beam according to a crystal orientation having a nonlinearity to be used, the phase matching condition, and a use application.

Incidentally, many nonlinear optical crystals having a periodical polarization inversion structure have a high nonlinear optical constant as compared with existing nonlinear optical crystals, so that high conversion efficiency can be obtained. In addition, nonlinear optical crystals having a periodical polarization inversion structure can be mass-produced by a wafer process technology, and are thus advantageous in reducing cost.

The size of the wavelength converting element needs to be larger by an appropriate amount than the beam size of the fundamental wave and the converted wave within the resonator. However, in practice, there is a limitation to increasing the size of nonlinear optical crystals and nonlinear optical elements of the various materials described above and nonlinear optical crystals provided with a periodical polarization inversion structure in particular. Thus, it is desirable to make adjustment without increasing the effective diameter of the end surface that the fundamental wave enters, that is, it is desirable that device configuration be easy so as to facilitate adjustment. Optical adjustment is facilitated when the pumping direction and the direction of emission of the converted wave are parallel with each other as described above. That is, there is an advantage of also simplifying the adjustment of the wavelength converting element when appropriately selecting the angle.

Description will next be made of an example of an embodiment in which a pumping direction and the direction of emission of a converted wave are thus made substantially parallel to each other.

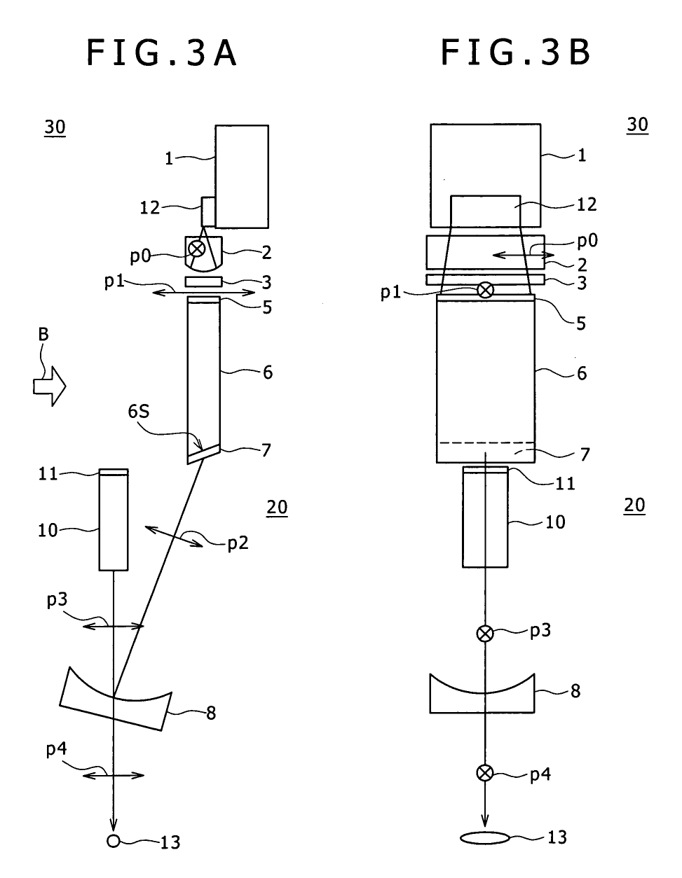

FIGS. 3A and 3B are schematic plan configuration views of an example of a laser light source device according to an embodiment of the present invention. FIG. 3A is a plan configuration view within a plane along a plane of incidence in a reflected light path within a resonator 20 formed by a pair of resonator mirrors 5 and 11. FIG. 3B is a schematic plan configuration view as viewed from a direction along the plane (a direction indicated by an arrow B in FIG. 3A).

In the example shown in FIGS. 3A and 3B, an end pump system is employed in which pumping light is made incident from an end surface of a laser medium 6 along the direction of the resonator, and another end surface of the laser medium 6 is provided as an inclined surface 6S to which a polarizing film 7 having a higher transmittance for polarized light in the plane of incidence of a fundamental wave is attached. In this case, the longitudinal direction of the linear fundamental wave is substantially perpendicular to the plane of incidence of a reflecting part that folds back a resonant light path.

As shown in FIGS. 3A and 3B, the laser light source device 30 has a collimator lens 2, a half-wave plate 3, and a laser medium 6 disposed on an optical path of pumping light emitted from a pumping light source 1. An end surface of the laser medium 6 on the side of the pumping light source 1 is a perpendicular surface substantially orthogonal to an optical axis, and is the resonator mirror 5 formed by a high reflectance film. Another end surface of the laser medium 6 is an inclined surface 6S having an angle other than the Brewster angle. A polarizing film 7 is provided on the inclined surface 6S. Material and layer configuration of the polarizing film 7 are selected such that the polarizing film 7 has a relatively high transmittance for polarized light in a paper plane indicated by an arrow p1 in FIG. 3A and has a relatively low transmittance for polarized light orthogonal to the polarized light in the paper plane, thereby the polarizing film 7 on the inclined surface 6S can be made to function as a polarized light selecting element.

Then, a reflecting part 8 formed by a concave mirror or the like is disposed on the emission optical path of light emitted from the laser medium 6, and a wavelength converting element 10 is disposed on the optical path of the reflected light. Though not shown in the figures, a reflection preventing film for the fundamental wave and the converted wave is provided on an end surface of the wavelength converting element 10 on the side of the reflecting part 8. The resonator mirror 11 is provided on another end surface of the wavelength converting element 10. In this case, the resonator mirror 5 has a high reflectance for the fundamental wave. The reflecting part 8 has a high reflectance for the fundamental wave, and has for example a high transmittance for the converted wave. The resonator mirror 11 for example has a high reflectance for the fundamental wave and the converted wave. Incidentally, in this example, the resonator mirrors 5 and 11 are formed by a high reflectance film provided on one end surface of the laser medium 6 and the wavelength converting element 10, respectively. In this case, the number of parts is reduced, and optical adjustment is simplified.

In such a configuration, pumping light emitted form a light emitting element 12 of the pumping light source 1 is collimated by the collimator lens 2 such as a cylindrical lens or the like in a direction of emitter thickness of the light emitting element 12, for example, and is then made incident from one end surface of the laser medium 6, that is, the end surface provided with the resonator mirror 5 in this case, via the half-wave plate 3. At this time, in a case where the laser medium 6 is an anisotropic medium, for example Nd:YVO₄ whose crystal orientations providing high absorption efficiency and high oscillation efficiency are a same direction of a c-axis, when a pumping light source in which a direction of oscillating polarized light of a semiconductor laser is parallel with the direction of the emitter thickness is used, the polarized light is desirably rotated by 90 degrees by the half-wave plate 3 before entering the laser medium 6 so that the polarized light is aligned in a direction of polarization of the fundamental wave to be resonated, as in the example shown in the figures.

Specifically, in this case, the direction of polarization of the light emitted from the light emitting element 12 of the pumping light source 1 is a direction orthogonal to an optical axis and the paper plane of FIG. 3A and along the paper plane of FIG. 3B, as indicated by an arrow p0. The half-wave plate 3 changes the direction of polarization to a direction orthogonal to the optical axis, along the paper plane of FIG. 3A, and orthogonal to the paper plane of FIG. 3B, as indicated by an arrow p1. Because the other end surface of the laser medium 6 is the inclined surface 6S provided with the polarizing film 7, the light in the direction of polarization as indicated by the arrow p1 is emitted at a high transmittance. The direction of polarization of the fundamental wave emitted from the laser medium 6 is indicated by an arrow p2. The directions of polarization of the fundamental wave reflected by the reflecting part 8 and the converted wave converted by the wavelength converting element 10, transmitted by the reflecting part 8, and emitted to the outside are indicated by arrows p3 and p4, respectively. Incidentally, in the figures, a rough shape of a beam spot 13 is shown at an emission position after passing through the reflecting part 8.

Thus, in the example shown in FIGS. 3A and 3B, the functions of three elements, that is, the resonator mirror 5, the laser medium 6, and a Brewster plate can be achieved by one element, so that the number of parts can be reduced. The fundamental wave emitted from the laser medium 6 and reflected at the reflecting part 8 enters the wavelength converting element 10. The reflection preventing film for the fundamental wave is provided on the end surface of the wavelength converting element 10 on the side of the reflecting part 8, so that an optical loss within the resonator can be reduced and highly efficient fundamental wave oscillation can be obtained.

In addition, in this case, the direction of polarization is substantially orthogonal to the longitudinal direction of the fundamental wave. Therefore the direction of angular polarized light emitted from the inclined surface is a direction along the paper plane of FIG. 3A (a direction orthogonal to the paper plane of FIG. 3B), that is, a direction along the plane of incidence at the reflecting part 8 of the resonant light path. There is thus an advantage of simple arrangement and configuration of each optical part.

With the above configuration, a resonator can be formed between the resonator mirror 5 provided on one end surface of the laser medium 6 and the resonator mirror 11 provided on one end surface of the wavelength converting element 10 via the reflecting part 8 such as a concave mirror or the like.

In this example, the longitudinal direction of the fundamental wave is a direction perpendicular to the polarized light, that is, a direction perpendicular to the paper plane of FIG. 3A and along the paper plane of FIG. 3B, and the longitudinal direction of the fundamental wave is substantially perpendicular to the plane of incidence at the reflecting part 8, thereby the angle of incidence at the reflecting part 8 can be decreased with a small number of parts and a small optical loss in the resonator.

In the past, when such linear transverse multi-mode light is handled, the longitudinal direction of the fundamental wave is a direction along the plane of incidence of the reflecting part 8. As compared with such an existing arrangement, when the longitudinal direction of the fundamental wave is substantially orthogonal to the plane of incidence of the reflecting part 8 as shown in FIGS. 3A and 3B, there are advantages of being able to suppress a disturbance of symmetry in the longitudinal direction of the beam, being able to obtain uniform and stable beam shape, and being able to make uniform oscillation up to a high-order spatial mode.

In addition, the symmetry of the beam shape is well maintained even when there is a disturbance such as vibration or the like, and thus a power transition between spatial modes does not easily occur. When the laser light source device is used in an image generating device, an optical process device or the like, an improvement in uniformity, use efficiency, and stability of the linear laser light, and noise reduction can be achieved. Further, a manufacturing margin of the laser light source device and a laser module including the laser light source device is also increased.

In particular, in the embodiment of the present invention, the angle of inclination of the inclined surface provided to the laser medium 6 or the wavelength converting element 10 in correspondence with the reflection angle of the resonant light path can be set freely, that is, an angle at which the light is bent as a result of entering and being emitted from the inclined surface can be set. In this case, because the longitudinal direction of the fundamental wave is perpendicular to the plane of incidence of the reflecting part within the resonator, that is, perpendicular to the resonant light path, there is an advantage of not disturbing the symmetry of the transverse multi-mode even when the angle of inclination of the inclined surface provided to the laser medium 6 or the wavelength converting element 10 is set freely. Hence, by providing the polarizing film having a polarized light separating effect on the fundamental wave at the angle of inclination of the corresponding inclined surface, a pumping direction and the direction of emission of the converted wave such as a harmonic or the like can be made substantially parallel with each other, as shown in FIGS. 3A and 3B.

As a result, a change between the pumping direction and the beam after being emitted from the laser medium can be made smaller, which is convenient in miniaturizing the laser light source device. In addition, a surface where for example a laser diode of the pumping light source 1 is mounted becomes substantially parallel to the direction of emission of the converted wave such as a harmonic or the like. There are thus advantages of ease of making the mechanical external shape of the laser light source device and in turn the exhaust heat surface of the pumping light source parallel with the emission direction and ease of fabricating a structure that is easy to assemble and handle. Thus, according to the embodiment of the present invention, it is possible to achieve miniaturization of the laser light source device and ease of assembly, and achieve both stability and high conversion efficiency.

Description will next be made of a result of comparison between an existing constitution in which an end surface is a Brewster surface and a constitution in which an inclined surface at an angle other than the Brewster angle is used as in the embodiment of the present invention in a case of using a laser medium with a particularly large angle of refraction.

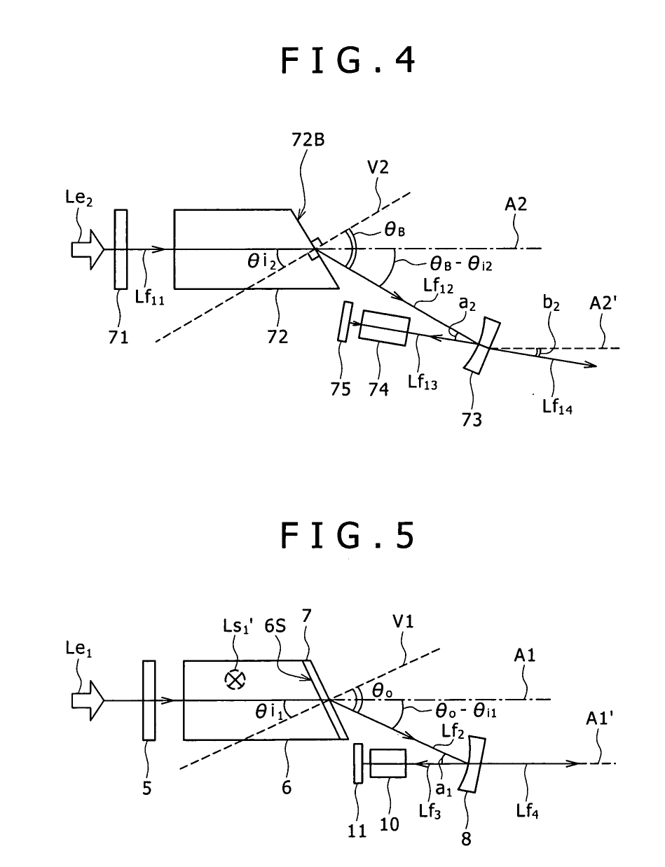

FIG. 4 and FIG. 5 are diagrams of configuration of laser light source devices including a resonator having a folded-back reflection light path. Description will be made of an angle of emission of a converted wave with respect to a traveling direction of a fundamental wave. FIG. 4 shows a comparative example in which an inclined surface is a Brewster surface. FIG. 5 shows an example of a laser light source device according to an embodiment of the present invention in which a polarizing film is provided on an inclined surface at an angle other than the Brewster angle.

First, in the example shown in FIG. 4, a laser medium 72 whose end surface 72B is a Brewster surface, a folding-back mirror 73, a wavelength converting element 74 such as a nonlinear optical crystal or the like are provided within a resonator formed by a pair of resonator mirrors 71 and 75. Light emitted from a pumping light source of a semiconductor laser or the like not shown in the figure enters for example the resonator mirror 71, as indicated by an arrow Le₂, and then enters the inside of the resonator from the resonator mirror 71, as indicated by an arrow Lf₁₁. A fundamental wave pumped within the laser medium 72 is emitted from the end surface 72B as a Brewster surface as indicated by an arrow Lf₁₂, is reflected at the folding-back mirror 73 as indicated by an arrow Lf₁₃, and then reaches the resonator mirror 75 via the wavelength converting element 74.

The resonator mirrors 71 and 75 have a high reflectance for the fundamental wave oscillating in the laser medium 72, and have for example a high reflectance for a harmonic converted in the wavelength converting element 74. The reflecting surface of the folding-back mirror 73 has a high reflectance for the fundamental wave, and has for example a high transmittance for the converted wave. With such a configuration, the converted wave such as a second harmonic or the like produced by irradiating the wavelength converting element 74 with the fundamental wave obtained by oscillating, by the laser resonator, the light generated by the pumping light with which the laser medium 72 is irradiated can be emitted to the outside as indicated by an arrow Lf₁₄. In FIG. 4, a broken line A2 represents the traveling direction of the pumping light within the laser medium 72, that is, the pumping direction, a broken line v2 represents a normal to the end surface 72B, and a broken line A2′ represents a direction parallel to the broken line A2.

In this example, when the laser medium 72 is for example an Nd:YAG crystal, a refractive index n for light having a wavelength of 1064 nm is

n=1.82

The Brewster angle θ_{B} is

θ_{B}=arctan(n)=61.2°

The angle θi₂ of internal refraction of the crystal is

θi₂=arcsin[sin(θ_{B})/n]=28.8°

Hence, an angle at which light is bent as a result of entering and being emitted from the Nd:YAG crystal is

θ_{B}−θi₂=32.4°

In this case, supposing that the angle a₂ of reflection of the folding-back mirror 73 in the resonant light path is 20°, for example, the angle b₂ of emission of the converted wave represented by the arrow Lf₁₄ with respect to the pumping direction represented by the broken line A2′ is

b₂=32.4°−20°=12.4°

This represents a limiting factor limiting the miniaturization, ease of production, and ease of use of the laser device as a whole. The angle a₂ of reflection of the resonant light path can be changed in order to extract the converted wave in parallel with the pumping direction. In this case, the direction of emission of the converted wave can be made parallel with the pumping direction by for example setting the angle a₂ of reflection of the folding-back mirror 73 as follows.

a₂=θ_{B}−θi₂=32.4°

However, thus increasing the angle a₂ of reflection can cause an unintended aberration.

The occurrence of such an aberration makes it difficult to simplify and miniaturize the device configuration because an optical element for correcting the aberration is desired separately, for example, or invites a degradation in laser beam profile and instability. In addition, there arises a need to dispose optical elements at a predetermined angle and a predetermined position, so that the design of the device and manufacturing operation become complicated.

When a laser medium having a larger angle of refraction than Nd:YAG is used, the bending angle is further increased. For example, Nd:YVO₄ has a relatively large angle of refraction, and has an extraordinary ray refractive index n=2.16. By a similar calculation, an angle at which light is bent as a result of entering and being emitted from the Nd:YVO₄ crystal at the Brewster angle is

θ_{B}−θi₂=40.4°

The bending angle becomes larger. Hence, when the pumping direction and the direction of emission of the harmonic are to be made substantially parallel to each other, the angle of reflection of the reflecting part 73 needs to be 40.4°, which further increases effects of comatic aberration and spherical aberration.

On the other hand, in the laser light source device according to an embodiment of the present invention, the angle of inclination is not limited to the Brewster angle, and thus such an inconvenience can be avoided. FIG. 5 shows a general configuration of the laser light source device in this case. In FIG. 5, parts corresponding to those of FIG. 1 and FIG. 2 are identified by the same reference numerals, and repeated description thereof will be omitted. Light emitted from a pumping light source of a semiconductor laser or the like not shown in the figure enters for example a resonator mirror 5, as indicated by an arrow Le₁, and then enters the inside of a resonator from the resonator mirror 5. A fundamental wave pumped in a laser medium 6 is emitted from an inclined surface 6S at an angle of inclination other than the Brewster angle as indicated by an arrow Lf₂, and is reflected at a folding-back mirror 8 as indicated by an arrow Lf₃. The fundamental wave then reaches a resonator mirror 11 via a wavelength converting element 10.

The resonator mirrors 5 and 11 have a high reflectance for the fundamental wave oscillating in the laser medium 6, and have for example a high reflectance for a harmonic converted in the wavelength converting element 10. The reflecting surface of the folding-back mirror 8 has a high reflectance for the fundamental wave, and has for example a high transmittance for the converted wave. With such a configuration, the converted wave such as a second harmonic or the like produced by irradiating the wavelength converting element 10 with the fundamental wave obtained by oscillating, by the laser resonator, the light generated by the pumping light with which the laser medium 6 is irradiated can be emitted to the outside as indicated by an arrow Lf₄. In FIG. 5, a broken line A1 represents the traveling direction of the pumping light within the laser medium 6, that is, the pumping direction, a broken line v1 represents a normal to the inclined surface 6S, and a broken line A1′ represents a direction parallel to the broken line A1.

As shown in FIG. 5, the embodiment of the present invention makes it possible to set an angle at which light is bent as a result of entering and being emitted from the laser medium 6 according to the angle of reflection of a resonant light path, and make the pumping direction represented by the broken line A1 substantially parallel with the direction of emission of the converted wave represented by the broken line A1′.

For example, when the angle of inclination (angle formed by the direction of the light path and the inclined surface 6S) of a Nd:YAG crystal is set at 65.2°, the angle θi₁ of internal refraction of the crystal is

θi₁=90−65.2=24.8°

An angle of incidence outside the inclined surface 6S side of the laser medium 6 is

θ₀=arcsin[sin(θi₁)×n]=49.8°

An angle at which light is bent as a result of entering and being emitted from the Nd:YAG crystal at the angle of inclination is

θ₀−θi₁=25°

The angle can be decreased as compared with the case in which the Brewster angle is used.

In this case, the polarizing film 7 provided so as to have a polarized light separating effect on the fundamental wave at the angle of the inclined surface 6S can sufficiently suppress parasitic polarized light oscillation within the laser resonator. Then, as described above, when the angle a₁ at which the resonant light path is folded back is made to coincide with the difference in angle (θ₀−θi₁=25°) between light entering the Nd:YAG crystal and light emitted from the Nd:YAG crystal, an arrangement and a configuration can be achieved in which for example the external shape of the laser medium 6 and the pumping direction and, in turn, the exhaust heat surface of the pumping light source are substantially parallel with the direction of emission of the converted wave. With such a configuration, it is possible to miniaturize the laser light source device, facilitate assembly of the laser light source device, and provide a laser that generates a converted wave stably and efficiently.

Such effects obtained by the embodiment of the present invention become more noticeable when a laser medium having a large angle of refraction is used. For example, supposing that the angle of inclination of the inclined surface 6S is 71.4° in a case where a Nd:YVO₄ crystal is used as the laser medium 6, the angle of internal refraction of the Nd:YVO₄ crystal for an extraordinary ray is θi₁=18.6°, and an angle of incidence outside the crystal is θ₀=43.6°. Again, an angle at which light is bent as a result of entering and being emitted from the Nd:YVO₄ crystal at the angle of inclination is

θ₀−θi₁=25°

Supposing that the angle of inclination of the inclined surface 6S is 74.4° in a case where a Nd:YVO₄ crystal is similarly used as the laser medium 6, by a similar calculation,

θ₀−θi₁=20°

Thus, the bending angle can be further decreased. By making the angle a₁ at which the resonant light path is folded back coincide with the bending angle, for example the external shape of the laser medium and the pumping direction and, in turn, the exhaust heat surface of the pumping light source can be made substantially parallel with the direction of emission of the converted wave, as in the above-described example. That is, the higher the refractive index of the laser medium, or the larger the angle of refraction of the material, the more noticeable the effects of the embodiment of the present invention.

Incidentally, while the laser medium 6 is provided with the inclined surface 6S in the above-described example, it is needless to say that the wavelength converting element may be similarly provided with an inclined surface on which to dispose the polarizing film. In this case, the polarizing film is desirably designed to have a high transmittance for not merely the fundamental wave but also the harmonic.

Incidentally, in the embodiment of the present invention, the reflecting part 8 in FIG. 5 has a high transmittance for the converted wave, and the resonator mirror 11 has a high reflectance for the converted wave. However, the embodiment of the present invention is not limited to this example. For example, the resonator mirror 11 may have a high transmittance according to a use.

In the present embodiment, the pumping system is of an end pump type. However, it is needless to say that the embodiment of the present invention can be applied to a side pump system. Specifically, while FIG. 5 shows the example of an end pump system, similar effects can be obtained in the case of a side pump system, in which the pumping light source is opposed to a side surface along the pumping direction of the laser medium 6 to irradiate the laser medium 6 with pumping light as indicated by a broken line Ls1′. Also in the side pump system, the laser medium is irradiated with pumping light along a plane including the direction of the light path of the laser medium, so that similar effects can be obtained, including for example an effect of being able to make the longitudinal direction of the beam of the pumping light source, that is, a surface where a laser diode or the like of the pumping light source is mounted substantially parallel to the direction of emission of the converted wave such as a harmonic or the like. Thus, it is similarly possible to miniaturize the laser light source device, improve ease of assembly of the laser light source device, and provide a laser light source device that generates a converted wave stably and efficiently.

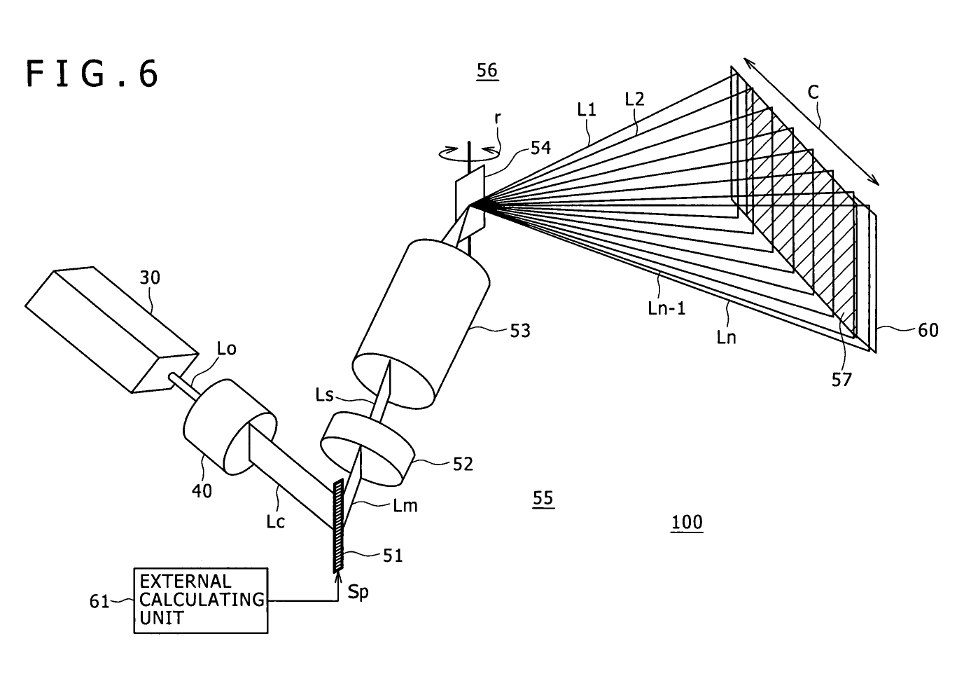

An embodiment of an image generating device using a laser light source device of a present invention configuration will next be described with reference to FIG. 6. As shown in FIG. 6, the image generating device 100 includes a laser light source device 30 of an embodiment of a present invention configuration, an illumination optical system 40, a light modulating unit 55 including a one-dimensional light modulating device 51 of a diffraction grating type, for example, and a light selecting unit 52, a projection optical unit 53, and a scanning optical unit 56 having a scanning element 54. The laser light source device 30 can be configured to output for example a one-dimensional converted wave in a transverse multi-mode as in the foregoing embodiment, for example a second harmonic. Laser light Lo emitted from the laser light source device 30 and whose beam shape or the like is adjusted in the illumination optical system 40 is applied as a linear light beam to the one-dimensional light modulating device 51 of a diffraction grating type configuration, for example.

The one-dimensional light modulating device 51 of a diffraction grating type operates receiving a signal Sp from a driving circuit not shown in the figure on the basis of an image signal generated in an external calculating unit 61. When the one-dimensional light modulating device 51 is of a diffraction grating type configuration, diffracted light Lm of the one-dimensional light modulating device 51 enters the light selecting unit 52. Incidentally, when light of three primary colors is used, for example, beams from light sources of the respective colors may be respectively passed through one-dimensional illumination devices and light modulating devices for the respective colors, and then superimposed on one another by a color synthesizing unit such as an L-shaped prism or the like to be emitted to the light selecting unit.

The light selecting unit 52 is formed by an Offner relay optical system or the like, and has a spatial filter (not shown) such as a Schlieren filter or the like. In this case, +1 st order light, for example, is selected, and emitted as one-dimensional image light Ls. Further, magnification and the like are performed by the projection optical unit 53, and scanning is performed as indicated by L1, L2, . . . , Ln−1, and Ln by rotation of the scanning element 54 in the scanning optical unit 56 which rotation is indicated by an arrow r, so that a two-dimensional image 57 is generated on an image generating plane 60 such as a screen or the like. Scanning positions are scanned as indicated by an arrow C on the image generating plane 60. For example, not merely a galvanomirror and a polygon mirror but also a so-called resonant scanner that performs scanning by resonance using an electromagnet or the like can be used as the scanning element 54.

For example, a GLV (Grating Light Valve: reflection type diffraction grating) type light modulating element developed by Silicon Light Machines (SLM) of the U.S., which element is a one-dimensional optical modulating element, can be used as the light modulating device. This GLV element is irradiated with linear light in the transverse multi-mode which light is emitted from the laser light source device 30 of an embodiment of a present invention configuration, for example linear light in the transverse multi-mode by a semiconductor laser array, a parallel light source or the like.

The image generating device 100 of the above-described configuration, which uses a laser light source device of an embodiment of a present invention configuration as the laser light source device 30, can have a small configuration, and use a stable and highly efficient converted wave. Therefore an image can be generated with little illumination variation and good image quality.

It is to be noted that the image generating device according to the foregoing embodiment of the present invention is not limited to the example described above. For example, when laser light source devices are provided for respective colors of red, green, and blue, it suffices for at least one of the laser light source devices to have an embodiment of a present invention configuration. In addition, various modifications and changes can be made in other parts, that is, the light modulating unit, the projection optical unit, the scanning optical unit, and the like. In addition, the embodiment of the present invention is not limited to projection type display, and is applicable to various drawing devices that generate text information, an image and the like by drawing, for example laser printers.

In addition, the image generating device according to the foregoing embodiment of the present invention is not limited to a case where the above-described one-dimensional light modulating device is used, and is applicable to cases where other light modulating devices of a two-dimensional type such as DMDs (Digital Micro-mirror Devices), resonant type scanning mirrors and the like are used. In addition, it is needless to say that various modifications and changes can be made in materials and constitutions of an illumination optical system, a projection optical system, and other optical systems other than the laser device of a light source without departing from the embodiment of the present invention configurations.

Further, in a case of an optical device other than the image generating device which optical device uses one or more laser devices having a wavelength converting element within a resonator, the embodiment of the present invention is applicable to at least one laser light source device of the optical device.

In addition, the laser light source device according to the foregoing embodiment of the present invention is not limited to the configurations described in the examples of the foregoing embodiment, and is susceptible of various other modifications and changes without departing from the embodiment of the present invention configurations.

It should be understood by those skilled in the art that various modifications, combinations, sub-combinations and alterations may occur depending on design requirements and other factor in so far as they are within the scope of the appended claims or the equivalents thereof.

What is claimed is:

1. A laser light source device comprising:
a pumping light source;
a pair of resonator mirrors;
a laser medium and a wavelength converting element within a resonator formed by said resonator mirrors;
said laser medium being pumped by light in a transverse multi-mode pattern, said wavelength converting element being irradiated with a linear fundamental wave obtained by oscillation of said laser medium, and a linear converted wave being output;
a reflecting part for folding back a resonant light path, said reflecting part being disposed on the light path between said laser medium and said wavelength converting element;
an end surface of one of said laser medium and said wavelength converting element being formed as an inclined surface at other than a Brewster angle; and
a polarizing film disposed on said inclined surface.

2. The laser light source device according to claim 1, wherein
a birefringent material is used as one of said laser medium and said wavelength converting element.

3. The laser light source device according to claim 1, wherein
a longitudinal direction of said linear fundamental wave is substantially perpendicular to a plane of incidence of said reflecting part.

4. The laser light source device according to claim 1, wherein
one end surface of one of said laser medium and said wavelength converting element is worked so as to be substantially perpendicular to the resonant light path, and a high reflectance film having a high reflectance for said fundamental wave is formed as said resonator mirror on said one end surface.

5. An image generating device comprising:
a laser light source device;
a light modulating unit for modulating light emitted from said laser light source device so as to correspond to information; and
a projection optical unit, wherein
said laser light source device includes
a pumping light source,
a pair of resonator mirrors,
a laser medium and a wavelength converting element within a resonator formed by said resonator mirrors,
said laser medium is pumped by light in a transverse multi-mode pattern, said wavelength converting element is irradiated with a linear fundamental wave obtained by oscillation of said laser medium, and a linear converted wave is output,
a reflecting part for folding back a resonant light path is disposed on the light path between said laser medium and said wavelength converting element,
an end surface of one of said laser medium and said wavelength converting element is formed as an inclined surface at other than a Brewster angle, and
a polarizing film is disposed on said inclined surface.
